(19) United States
(12) Patent Application Publication
(10) Pub. No.: US 2014/0230966 A1
(43) Pub. Date: Aug. 21, 2014

(54) Method for Producing a Grain-Oriented Electrical Steel Strip or Sheet Intended for Electrotechnical Applications

(71) Applicant: Thyssenkrupp Steel Europe AG, Duisburg (DE)

(72) Inventors: Andreas Boettcher, Duisburg (DE); Ludger Lahn, Moers (DE); Gerhard Inden, Ratingen (DE); Eberhard Sowka, Dinslaken (DE)

(21) Appl. No.: 14/347,679

(22) PCT Filed: Sep. 20, 2012
(86) PCT No.: PCT/EP2012/068525

§ 371 Date: Mar. 27, 2014

(30) Foreign Application Priority Data
Sep. 28, 2011 (DE) 102011054004.0

(51) Int. Cl. H01F 1/147; C21D 8/02

(52) U.S. Cl. CPC H01F 1/14775; C21D 8/0226; C21D 8/0247
USPC 148/226; 148/603

(57) ABSTRACT

A method for producing a grain-oriented electrical steel strip or sheet, in which the slab temperature of a thin slab consisting of a steel having (% wt.) Si: 2-6.5%, C: 0.02-0.15%, S: 0.01-0.1%, Cu: 0.1-0.5%, wherein the Cu to S content ratio is % Cu/% S>4, Mn: up to 0.1%, wherein the Mn to S content ratio is % Mn/% S<2.5, and optional contents of N, Al, Ni, Cr, Mo, Sn, V, Nb, is homogenised to 1000-1200° C. The thin slab is hot rolled into a hot strip having a thickness of 0.5-4.0 mm at an initial hot-rolling temperature of <=1030° C. and a final hot-rolling temperature of >=710° C., with a thickness reduction in the first and in the second hot-forming passes of >=40%. The hot strip is cooled, coiled, and cold rolled into a cold strip having a final thickness of 0.15-0.50 mm. An annealing separator is applied onto the annealed cold strip to form a Goss texture.

The invention relates to a method for producing a grain-oriented electrical steel strip or sheet intended for electrotechnical applications. Such electrical steel strips or sheets are characterised by a particularly sharply pronounced {110}<001> texture which has a slight direction of magnetisation parallel to the rolling direction. Such a texture is also called a “Goss texture” after the discoverer.

The Goss texture is formed by means of a selective abnormal grain growth which is also referred to as secondary crystallisation. Here, the natural tendency of a metallic matrix to grain size enlargement is suppressed by the presence of grain growth inhibitors which in the technical language are also for short called “inhibitors” or the “inhibitor phase”.

The inhibitor phase consists of very fine particles, distributed as homogenously as possible, of one or more foreign phases. The respective particles already have a natural boundary surface energy on their respective boundary surface bordering on the matrix. A grain boundary moving over it is thereby impeded because the further saving on boundary surface energy is greatly reduced in the whole system.

The inhibitor phase hence has a central importance for the formation of the Goss texture and as a consequence thereof for the magnetic properties of the respective material. Here, the homogenous distribution of very many much smaller particles is important. Since the number of precipitated particles cannot be experimentally deduced, their size sheds light on their effect. Hence, it is understood that the particles of the inhibitor phase should, on average, not be essentially larger than 100 nm.

A first method for producing electrical steel strips or sheets with a Goss texture has been described in U.S. Pat. No. 3,438,820. According to this method, MnS is used as the inhibitor. The slabs conventionally produced in ingot or continuous casting must be heated up to temperatures close to 1400° C. for this purpose. In this way, the coarse primary MnS precipitations are brought into solution again and can be precipitated in a finely dispersed manner in the required way in the course of the subsequent hot-rolling process. Since the hot strip produced in this way already has the required grain growth inhibition, this type of grain growth control is referred to as “inherent inhibition”.

The grain growth inhibiting effect of the MnS phase is, however, limited such that, starting from usual hot strip thicknesses of e.g. 2.30 mm, cold rolling to the application thickness of the strip has to be carried out in at least two stages and between the individual cold rolling stages a recrystallising intermediate annealing operation has to be carried out, in order to obtain the desired properties. However, the material inhibited by MnS only achieves a limited texture sharpness in the course of this treatment, in which the Goss position deviates from the ideal position by on average 7°. This texture sharpness is reflected in a comparably low magnetic polarisation J₈₀₀ with a field strength of 800 A/m, which can only rarely exceed values of 1.87 T. The commercial name for material constituted in this way is “Conventional Grain Oriented” material or “CGO” material for short.

With the method published in U.S. Pat. No. 3,159,511, it is possible to produce grain-oriented electrical steel strip which with deviations from the ideal position of only about 3° has a distinctly better texture sharpness. This was achieved by using AlN as an additional inhibitor phase. This complements the inhibiting effect of MnS. The AlN inhibitors are already precipitated in their definitive way in the ferritic areas during hot rolling. However, a C content, which is increased compared to CGO, provides the option of re-dissolving the AlN particles in the austenitic areas in a subsequent hot strip annealing operation and precipitating them in a finely dispersed and very controlled manner. This is possible at technically easily achievable temperatures in a continuous annealing line because the solubility temperature of approximately 1100-1150° C. of AlN in the austenite is distinctly lower than in the ferrite. Despite this double formation of the AlN inhibitor phase, inherent inhibition is also referred to here because it is already applied in the hot strip. As a result, it was possible to produce high-grade grain-oriented electrical steel sheets using a single-stage cold-rolling process. The material created in this way is called “High Permeability Grain Oriented” material or “HGO” material for short.

In DE 23 511 41 A1 it was additionally disclosed that SbSe could also be used as the inherent inhibitor phase.

Each of the previously mentioned known methods, which are based on inherent inhibitors already applied in the hot strip, requires very high slab heating temperatures above 1350° C. This, apart from a considerable use of energy and a high amount of technical effort, additionally results in large amounts of liquid slag accumulating during annealing. This puts a considerable strain on the annealing equipment respectively used and creates considerable maintenance costs.

In order to remedy these disadvantages, so-called “low-heating methods” were developed. These methods provide a low slab pre-heating temperature, which is below 1300° C. and is typically at 1250° C., and are based on the fact that the inhibitor phase is not already formed in the hot strip but only in a later stage of the overall manufacturing procedure. The manufacture of such electrical steel strips or sheets starts with a steel which already has certain amounts of Al in its chemical composition. By means of suitable nitriding, the inhibitor phase AlN is then formed in the strip which has been cold rolled to the application thickness. Thus, this inhibitor phase is not already inherent in the hot strip but is only produced in a later step of the cold strip processing. This process is also referred to as “acquired inhibition” in the technical language.

An example of the method for producing an electrical steel sheet or strip based on acquired inhibition is described in EP 0 219 611 B1.

Furthermore, methods for producing electrical steel strips or sheets are described in EP 0 648 847 B1 and EP 0 947 597 B1, in which mixed forms of inherent and acquired inhibition are used. In the case of these methods, the slab heating temperatures are set in such a way that they are above the temperature with the low-heating method but are below that temperature limit which if exceeded leads to unwanted liquid slag formation in the course of annealing. As a result of lowering the annealing temperature, only a limited inherent inhibition takes place which on its own does not allow the formation of sufficient magnetic properties in the finished material. An additional nitriding treatment is carried out to compensate for this. The additional acquired inhibition brought about in this way in combination with the inherent inhibition ensures an adequate overall inhibition.

A nitriding treatment, as is required with the methods which rely on an acquired inhibition, is, if it is carried out in a continuous annealing furnace, technically complex, cost-intensive and, due to the surface reactions which have to be controlled very precisely, can often be difficult to control. Other nitriding treatments using nitrogen-donating adhesion protection additives are only effective to a limited extent.

Therefore, efforts have been made to develop inhibition systems which are inherent and, at the same time, suitable for low-heating processing. One method aimed in this direction is disclosed in EP 0 619 376 B1. According to this method, only Cu sulphide is used as the inhibitor phase. Cu sulphides have a distinctly lower solubility temperature than MnS, AlN and other inhibitor systems known up until then, so that with the methods for producing electrical steel strip or sheet based on Cu sulphides distinctly lower slab pre-heating temperatures suffice. On the other hand, however, it has to be accepted that the grain-oriented steel flat products produced in this way consistently will not obtain the magnetic properties which are expected from a HGO material.

All of the previously described known methods are based on the fact that conventionally cast slabs having slab thicknesses which are distinctly over 150 mm are used as the starting material. After the respective melt has been cast into slabs, the slabs initially cool to room temperature.

This disadvantage can be prevented by using the so-called “casting-rolling process”, in which the respective steel melt is firstly cast into a billet of comparably narrow thickness, from which then the so-called “thin slabs” are separated, the thickness of which is typically in the range from 30-80 mm. The big economic advantage of this approach is that between the production and further processing of the thin slabs they no longer have to be cooled to ambient temperature and subsequently re-heated. Instead, after they have been produced the thin slabs pass through an equalisation furnace positioned in line with the continuous casting plant, in which they are subjected to equalisation annealing to homogenise their temperature distribution and to set the temperature required for the hot-rolling process subsequently executed. The thin slabs can then be hot rolled directly afterwards. This process flow produces significant logistical and cost advantages.

A method using the casting-rolling process for producing electrical steel strips or sheets is described in EP 1 025 268 B1. In this method, a suitably composed melt is continuously cast in a vertical ingot mould, wherein the melt begins to solidify on the surface of the bath and the billet formed in this way is conveyed by way of a circular arc into the horizontal position and cooled. This billet has a thickness of only 25-100 mm, preferably 40-70 mm. Its temperature does not fall below 700° C. Thin slabs are separated from the billet heated in such a way in a continuously running process, these thin slabs subsequently being directly conveyed through the equalisation furnace positioned in line, in which they remain for at most 60 minutes, preferably for up no 30 minutes. With this pass through the equalisation furnace, the thin slabs are homogenously heated through and in the process reach a comparatively low temperature of at most 1700° C. Directly afterwards, the thin slabs are conveyed through a group of hot-rolling stands, in turn positioned in line with the equalisation furnace, where they are continuously hot rolled to the hot strip thickness of 0.5-3.0 mm. The hot strip thickness is preferably chosen such that the subsequent cold-rolling process only has to be carried out in one stage in order to achieve the required final thickness of the cold strip material obtained. The degree of deformation at which this cold rolling is carried out depends on the respective inhibitor effect which can be set differently.

Due to the limited high temperature strength of the thin slabs and the necessity of transporting them on a roller conveyor, in the casting-rolling process the temperature of the thin slabs is not allowed to exceed 1200° C. For this reason, up to now only the use of acquired inhibitors by means of a nitriding treatment was considered for producing grain-oriented electrical steel sheets or strips in combination with the casting-rolling process. Such methods are described in WO 2007/014867 A1 and WO 2007/014868 A1 respectively.

Against this background, of the previously explained prior art, the object of the invention was to specify a method which permits grain-oriented electrical steel strips or sheets to be produced cost-effectively and with reduced operational effort using the casting-rolling process, the magnetic properties of which grain-oriented electrical steel strips or sheets at least correspond to the properties of CGO material.

In order to achieve this object, the invention proposes a method, the production steps of which are carried out in accordance with Claim 1.

Advantageous embodiments of the invention are specified in the dependent claims and are explained in detail below together with the general concept of the invention.

A method according to the invention for producing a grain-oriented electrical steel strip or sheet intended for electrotechnical applications according to this comprises the following production steps:
a) providing a thin slab which consists of a steel which contains, in addition to iron and unavoidable impurities, (in % wt.) Si: 2-6.5%, C: 0.02-0.15%, S: 0.01-0.1%, Cu: 0.1-0.5%, wherein % Cu/% S>4 applies for the % Cu/% S ratio of the Cu content % Cu to the S content % S, Mn: up to 0.1%, wherein in the presence of Mn, % Mn/% S<2.5 applies for the % Mn/% S ratio of the Mn content % Mn to the S content % S, and in each case optionally N: up to 0.003%, contents of acid-soluble Al of up to 0.08%, wherein in the presence of Al, % N/% Al<0.25 applies for the % N/% Al ratio of the N content % N to the Al content % Al, one or more elements from the group “Ni, Cr, Mo, Sn” with contents of up to 0.2% in each case, one or more elements from the group “V, Nb” with contents of up to 0.1% in each case,
b) homogenising the temperature of the thin slab to a slab temperature of 1000-1200° C.,
c) hot rolling the thin slab into a hot strip having a thickness of 0.5-4.0 mm, wherein the hot-rolling initial temperature of the slab at the start of hot rolling is less than 1030° C. and the hot-rolling final temperature is at least 710° C. and both the first and the second hot-forming passes are carried out with a thickness reduction of at least 40%,
d) cooling the hot strip,
e) coiling the hot strip into a coil,
f) cold rolling the hot strip into a cold strip having a final thickness of 0.15-0.50 mm,
g) applying an annealing separator onto the surface of the annealed cold strip,
h) final annealing of the cold strip provided with the annealing separator to form a Goss texture.

When the steel alloy favourable for producing electrical steel strip or sheet according to the invention was determined, the invention started from a base alloy system which is known for grain-oriented electrical steel strip or sheet per se and which, in addition to iron and unavoidable impurities, had an Si content of 2-6.5% wt., typically about 3.2% wt., and contained further alloying elements in order to set the characteristics of the electrical steel strip or sheet produced according to the invention. Carbon, sulphur, nitrogen, copper, manganese, aluminium and chromium were such alloying elements which were especially considered.

Thermodynamic model calculations were carried out on this multi-component alloy system. The special feature here was a dynamic approach in relation to time. This approach was based on the finding that the conditions of equilibrium when producing electrical steel sheet or strip should not take centre stage but rather those processes of diffusion and precipitation which can be represented within technically realistic times. The interactions between the alloying elements could be considered by means of the model calculations. Above all, competing processes could be observed in the precipitation processes controlled by diffusion.

Silicon causes an increase in the specific resistance in electrical steel strips or sheets and hence a reduction in core loss. With contents of below 2% wt., the properties required for use as grain-oriented electrical steel strip are no longer obtained. Optimum processing properties result if the Si contents are in the range from 2.5-4% wt. With Si contents of more than 4% wt. a certain brittleness in the steel strip occurs, but with Si contents of up to 6.5% wt. the magnetostriction, which causes noise, is minimised. However, even higher Si contents do not seem to be useful due to the saturation polarisation being reduced too sharply.

Carbon within a certain framework causes microstructure homogenisation during annealing. For this purpose, a steel processed according to the invention has alloying contents of 0.020 to 0.150% wt., wherein the positive effect is particularly reliably reached with C contents of 0.040-0.085% wt., in particular 0.040-0.065% wt.

A particularly important component of the method according to the invention is that sulphides, which are precipitated during hot forming, are used as inhibitors in this method. This is because a uniform finely dispersed inhibitor particle distribution can only be achieved through the nucleation sites present during hot forming, as is necessary for an effective inhibition of grain growth, i.e. the formation of irregularly large grains, and hence good magnetic properties.

In this connection, the inventors have determined that AlN particles formed in the course of hot working are not suitable as a usable inhibitor either in the ferrite or in the austenite because both in the ferrite and in the austenite precipitations would always occur before beginning hot forming, which would lead to very few and, on top of that, very coarse particles, which would give rise to unfavourable properties in the electrical steel strip or sheet obtained.

Aluminium can, however, be used as a partner for nitrogen, which is added in an optionally carried out subsequent nitriding treatment, so that additional inhibitor particles in the form of AlN are then formed. For this purpose, the content of acid-soluble Al in the steel processed according to the invention may be up to 0.08% wt., wherein acid-soluble Al contents of 0.025-0.040% wt. have proved successful in practice.

In principle, the N content should be kept as low as possible and should not exceed 30 ppm. Nitrogen binds with Al to form AlN. In order that enough free Al remains available for an optional nitriding treatment, with the steel processed according to the invention, in the case of an effective presence of Al, % N/% Al<0.25 applies for the % N/% Al ratio of the N content % N to the Al content % Al.

Due to its composition, the method according to the invention is fully unaffected by the presence of aluminium. If the nitrogen content of the melt analysis is kept low, typically below 30 ppm, pure Al is present in the strip which is primarily recrystallised, decarburized and cold rolled into the finished strip thickness. This cold strip can then be subjected to a nitriding treatment during or after decarburization annealing, whereby AlN particles form in the strip which become effective as an additional inhibitor phase, so that a higher Goss texture sharpness can be formed which can produce magnetic properties which are usual with a conventional HGO material.

With this method, it is of particular practical use to be able to freely choose whether a nitriding treatment is to be carried out or not. If it is not carried out, then the Al remains in the material as an element and has no detrimental effect.

MnS is also unsuitable as an inhibitor for the method according to the invention, since the solubility temperature is so high here that MnS in each case clearly precipitates before the hot rolling, i.e. already during reheating of the respectively processed thin slab or on its way to the hot rolling installation used to carry out the hot rolling in each case. Furthermore, due to the strong affinity of manganese for sulphur, with higher Mn contents the sulphur content, which is provided in the steel for a specific purpose, would almost be fully bound. Correspondingly, with the use of MnS as the inhibitor hardly any free sulphur would be available for the formation of copper sulphides which takes place during hot forming.

Against this background, in the alloy processed according to the invention, the Mn content is limited to up to 0.1% wt. and, at the same time, in case of the presence of Mn the condition % Mn/% S<2.5 is specified for the % Mn/% S ratio of the Mn content % Mn to the S content % S.

In place of MnS, the invention uses CuS as the inhibitor. Although copper sulphides in the dynamic case fundamentally exhibit solubility temperatures which are so low that with the chemical compositions which are customary nowadays they only precipitate at temperatures at which in the case of the conventional production of grain-oriented electrical steel strip or sheet coiling of the hot strip takes place, with an uncontrolled and long precipitation time, as is unavoidable in the coil, the goal sought of a targeted finely dispersed inhibitor precipitation fails.

Therefore, according to the invention, the solubility temperature for copper sulphides was raised by means of alloying measures such that they can be precipitated during hot forming.

For this purpose, in the case of the alloy processed according to the invention, the Mn content is lowered as far as possible. The aim here is to reach the range of ineffectiveness, which is why the Mn range is limited to at most 0.1% wt., in particular at most 0.05% wt.

In addition, the sulphur content compared to typical grain-oriented electrical steel strip was increased to 0.01% wt. and hence increased to the extent that the mass ratio % Mn/% S is in each case<2.5, in particular <2. In this way, it is ensured that there is always a sufficient amount of free sulphur available for forming copper sulphides. By increasing the sulphur content, in the case of the steel processed according to the invention the solubility temperature and consequently also the precipitation temperature could be raised by more than 50° C. When “copper sulphides” are mentioned here, what is actually meant overall is the group of CuxSy compounds, even if these can have very different quantitative ratios.

In order to enable the desired precipitations of copper sulphides to take place, a steel processed according to the invention has not less than 0.1% wt. Cu. The upper limit of the Cu content is 0.5% wt., in order to prevent damage to the surface condition of the grain-oriented electrical steel sheet or strip produced according to the invention.

For the same reasons and to avoid problems during continuous casting, which are otherwise to be feared due to the presence of FeS, the S content of the steel according to the invention is at most 0.100% wt.

In addition to the chemical alloy composition, with the development of the method according to the invention as a further limiting condition, with a view to the thin slab casting-rolling technology to be used, a slab heating temperature up to a maximum of 1200° C. and times between casting and solidifying, homogenising annealing and hot rolling are assumed which can be achieved by casting machines available nowadays. The hot rolling pass scheme employed with the method according to the invention is also adapted in such a way that the temperature of the rolled material lies below the precipitation temperature for copper sulphide over as many hot-forming passes as possible.

Against this background, the steel composed according to the invention is processed in a way which is known per se into 35-100 mm thick, in particular at most 80 mm thick, thin slabs in the course of the process according to the invention. This is usually carried cut by conventional continuous casting.

Due to the high S content, the low Mn content at the same time and the accompanying formation of FeS, the casting rate should be selected as comparably low when casting the melt composed according to the invention into the billet, from which the thin slabs processed according to the invention are subsequently separated, in order to avoid the risk of billet breakouts. In practice, the casting rate during casting can be limited to at most 4.6 m/min for this purpose.

The overheating of the melt in the tundish is preferably 3-50 K. In particular, at overheating temperatures in the range from 25-50 K a sufficient amount of casting powder is fused onto the surface of the bath to ensure that there are the required amounts of slag for forming the lubricating film between the ingot mould and the billet shell. If a low overheating temperature of 3-25 K is set, the casting can be achieved by using a casting powder which, compared to casting with high overheating, modifies in such a way that it has an increased fusion rate. This can be brought about by adapting the amount and type of carbon carriers and increasing the flux proportion of the casting powder. The advantage of casting with very low overheating is that there is rapid billet shell growth in the ingot mould and a significant refinement of the solidification microstructure.

The parameters of the heat treatment taking place after the casting and of the production steps carried out during hot rolling of the thin slabs, are in particular set in such a way that problems are avoided which could otherwise be caused by the formation of liquid FeS (iron sulphide). In the approach according to the invention, in which after saturation of the manganese, which in any case is only present in small amounts, free sulphur is still available, liquid iron sulphide forms in the otherwise completely solidified matrix of the steel before copper sulphide forms. The liquid FeS causes such a hot brittleness that hot rolling would not be possible.

Here, the inventors have determined that from a % Mn/% S ratio<2.5 appreciable amounts of liquid FeS are present down to temperatures of around 1030° C. The further the % Mn/% S ratio is reduced in favour of sulphur, the higher are the contents by volume of liquid FeS formed. Hence, the invention makes provision for the temperature of the thin slab to be set to 1000-1200° C. before the hot rolling, wherein the optimum temperature range in practice is between 1020-1060° C. It is essential that the first forming pass of the hot-rolling process is carried out at a thin slab temperature of less than 1030° C., in particular of less than 1010° C. At the same time, it should be borne in mind that a certain temperature loss occurs when conveying the thin slab out of the equalisation furnace to the first hot-rolling stand, which under the conditions prevailing in practice usually amounts to up to 70° C. Practice-oriented temperatures of the first hot-rolling pass are in the range from 950-1000° C. and the temperature in the second hot-forming pass is 920-980° C.

Typically, the thin slabs are thermally homogenised over a period of 10-120 min in an equalisation furnace.

The thin slabs heated in the previously explained manner reach the group of hot-rolling stands respectively used according to the invention and are hot rolled there into a hot strip having a thickness of 0.5-4.0 mm.

In order to stimulate a particle precipitation which is as finely dispersed as possible, a sufficient number of nucleation sites should be provided in the temperature range within which the CuS particles form. These are provided by the dislocations in the material which are temporarily present during hot rolling. In order to provide a sufficiently large number of dislocations, the hot deformation degree obtained in the course of the first two rolling passes should therefore in each case be at least 40%. The “deformation degree” denotes the ratio of thickness reduction to the thickness of the rolled material before the respective rolling pass (deformation degree=(thickness of the rolled material before the rolling pass−thickness of the rolled material after the rolling pass)/(thickness before the rolling pass)).

The hot-rolling final temperature, i.e. the temperature of the hot strip obtained when leaving the last hot-rolling stand of the group of hot-rolling stands used for the hot rolling according to the invention, is at least 710° C. In practice, the temperatures of the rolled material during the last rolling pass typically are in the range from 800-870° C.

The hot strip produced in the manner according to the invention is suitable for producing grain-oriented electrical steel strip. Annealing the hot strip before cold forming is not obligatory but can optionally be carried out at temperatures of 950-1150° C., in order to increase the regions of the hot strip close to the surface which have an advantageous texture and thereby further improve the magnetic properties of the finished grain-oriented electrical steel strip or sheet.

The hot strip is cold rolled in one or more steps to the application thickness of 0.50-0.15 mm. If there is a plurality of cold rolling steps, a recrystallising intermediate annealing step is carried out in between.

During cold rolling, it can be advantageous to let the forming heat act on the strip for a few minutes (so-called “aging”). The dissolved carbon can thereby diffuse to the dislocations. In this way, the deformation energy in the strip introduced in the course of cold rolling is increased (Cottrell Effect).

After cold forming, a recrystallising and, at the same time, decarburizing annealing treatment takes place. The C content is in the process reduced to values below 30 ppm, so that only ferritically dissolved carbon is present in the matrix and no carbides can precipitate.

A nitriding treatment, in which the strip is annealed in an NH₃-containing annealing atmosphere, can already take place during or after the decarburizing annealing treatment, in order to thereby increase the N content of the strip.

Finally, the cold strip produced in this way is coated with an annealing separator, which usually consists of MgO, for subsequent high-temperature batch annealing. The annealing separator can contain nitrogen-donating additives which support the nitriding process. N-containing substances which thermally decompose in the range from 600-900° C. are particularly suitable for this purpose.

The high-temperature annealing leading to the secondary recrystallisation can take place in a manner which is known per se. According to a practice-oriented embodiment, it is carried out as a batch annealing operation, wherein heating rates of 10-50 K/h in the range between 400 and 1100° C. are achieved.

Subsequently, the electrical steel strip obtained is provided with a surface insulation layer in a continuous strip annealing and processing line and is stress-relieved. A domain refining treatment, carried out in a manner which is known per se, can also follow.

The invention is explained in more detail below by means of exemplary embodiments.

### EXAMPLE 1

A melt, which in addition to iron and unavoidable impurities has in % wt.) 3.05% Si, 0.045% C, 0.052% Mn, 0.010% P, 0.030% S, 0.206% Cu, 0.067% Cr, 0.030% Al, 0.001% Ti, 0.003% N, 0.011% Sn, 0.016% Ni, was cast into a billet, from which thin slabs having a thickness of 63 mm and a width of 1100 mm were separated. After free uncontrolled cooling down to approximately 900° C., homogenising annealing was carried cut, in which the thin slabs were heated through to 1050° C. Subsequently, the thin slabs were hot rolled into a hot strip having a hot-strip thickness of 2.30 mm in a group of hot-rolling stands comprising seven rolling stands passed through successively. The temperature of the rolled material was in the range from 960-980° C. in the first rolling pass, whereas in the second rolling pass it was 930-950° C. The final hot-rolling temperature was 840° C.

The hot strip obtained in this way was pickled without annealing and cold rolled in a cold-rolling step to the finished strip thickness of 0.285 mm. A recrystallising and decarburizing continuous annealing treatment followed this, in which the cold strip was annealed for 180 s at 850° C. in a moist atmosphere containing nitrogen, hydrogen and approximately 10% NH₃. Subsequently, the surface of the cold strip was coated with MgO as an annealing separator. The MgO annealing separator served as adhesion protection for a subsequent high-temperature batch annealing operation, in which the cold strip was heated up to a temperature of 1200° C. under hydrogen and at a heating rate of 20 K/h, at which temperature it was then held over 20 hours.

The finished strip obtained was finally provided with a phosphate coating and subsequently stress-relieved at 880° C. and afterwards uniformly cooled.

The grain-oriented electrical steel strip produced in the way described above exhibited good magnetic properties which lie in the range of commercially available HGO electrical steel strip. Its core loss at 50 Hz and 1.7 T excitation was 0.980 W/kg with a polarisation of 1.93 T under a magnetic field strength of 800 A/m.

### EXAMPLE 2

A melt A according to the invention and a melt B nor according to the invention were melted, the compositions of which are specified in Table 1.

The melts were cast into thin slabs having a thickness of 63 mm in the continuous casting process. The overheating temperature of the melt in the tundish was 25-45 K. The casting rate during continuous casting was in the range from 3.5-4.2 m/min. Subsequently, the billet cooled down to approximately 900° C. before entering the roller hearth furnaces.

The thin slabs separated from the billet were reheated in an equalisation furnace to temperatures between 1030 and 1070° C. for 20 minutes and then conveyed for hot rolling. The specifically set reheating temperatures SRT are also specified in Table 2 like the ratios % Mn/% S and % Cu/% S present in the alloys of the melts A and B.

On the way from the equalisation furnace to the first hot-forming pass, the temperature of the thin slabs sank to values around. 1000° C., wherein it was checked that the limit of 1030° C. which is critical for metallurgical reasons was absolutely unfailingly not exceeded.

The pass scheme of the hot-rolling train used for hot rolling the thin slabs and comprising seven rolling stands was designed in such a way that the first and the second forming passes produced a reduction degree of approximately 55% in the first hot-forming pass and approximately 48% in the second hot-forming pass. The temperature of the rolled material during the two first hot-forming passes was between 950 and 980° C. in the first pass and between 920 and 960° C. in the second pass. The hot-rolling final temperatures were in the range from 800-860° C. The hot strip thicknesses were in the range from 2.0-2.8 mm. The hot strips produced in this way were annealed at 1080° C. under a protective gas and then cooled with water in an accelerated manner. This was followed by surface descaling in a pickling bath.

The further processing comprised cold rolling in two stages with a recrystallising intermediate annealing operation to a finished strip nominal thickness of 0.30 mm, a subsequent recrystallising and decarburizing annealing operation, an application of an annealing separator essentially consisting of MgO and a high-temperature batch annealing operation to carry out the secondary recrystallisation, as well as an application of an insulator and stress-relieving flattening annealing at the end, wherein these production steps were carried out in a manner which is known per se from the prior art.

The average values of the magnetic properties P_{1.7} (core loss at 50 Hz and 1.7 T excitation), J₈₀₀ (polarisation under a field strength of 800 A/m) and the proportion of the magnetic degradation for the electrical steel strips produced from the melts A and B in the previously explained manner with the finished strip nominal thickness of 0.30 mm are specified in Table 3.

### EXAMPLE 3

A melt C composed according to the invention and a melt D not composed according to the invention with the compositions specified in Table 4 were, just like the melts A and B, cast in the previously described manner and manufactured into hot strip. Hot-strip, annealing and rapid cooling followed which were also carried out in the previously explained manner for the hot strips produced from the steels A and B.

Further processing followed via single stage cold-rolling to the finished strip nominal thickness of 0.23 mm and a subsequent recrystallising and decarburizing annealing operation, wherein during the decarburizing treatment nitriding simultaneously took place by adding 15% NH₃ to the annealing gas. Afterwards, an annealing separator essentially consisting of MgO was applied as adhesion protection and the secondary recrystallisation was carried out in a high-temperature batch annealing operation. Subsequently, the insulation coating was applied and stress-relieving flattening annealing was carried out. Finally, the finished strip was subjected to domain refining by laser treatment. As in Example 2, here the steps of processing the hot strip into a cold-rolled HGO electrical steel strip were carried out in a manner which is known per se from the prior art.

The reheating temperatures SRT set during the processing of the thin slabs produced from the melts C and D, as well as the % Mn/% S and % Cu/% S ratios, are specified in Table 5.

In Table 6, for the electrical steel strips produced from the melts C and D in the previously explained manner, for different regions of core losses P_{1.7} the proportions in % of those electrical steel strips which fall into the respective regions are specified. The lower the core losses P_{1.7} are, the better the quality of the respective electrical steel strips is. Electrical steel strips with core losses P_{1.7} of more than 0.95 W/kg no longer fulfil the requirements for grain-oriented electrical steel strips or sheets which apply today.

### EXAMPLE 4

Thin slabs consisting of the melt C were hot rolled using parameters deviating from the specifications according to the invention. The temperatures for the hot forming were specifically varied in the first two passes. This was made possible by setting the temperature of the equalisation furnace a bit higher at the start and beginning the hot forming at higher temperatures by means of a quick mode of operation. Subsequently, the equalisation furnace temperatures were reduced to the usual target value of the given plant and the hot-forming start temperatures were varied by different time lags.

The further processing of the hot strip into cold finished strip with a nominal thickness of 0.23 mm corresponded to the procedure previously explained for Example 3.

In Table 7, for the tests 1 to 18, the operating parameters respectively set when the tests were carried out of “reheating temperature SRT”, “Temperature θF1 of the rolled material during the first forming pass”, “Temperature θF2 of the rolled material during the second forming pass”, as well as the proportion in % of those electrical steel sheets produced in the tests, which fall into the respective region of core losses P_{1.7}, were specified.

The tests 1 to 13 carried out according to the invention with great reliability produce regularly good to very good electromagnetic properties, whereas in the case of the tests 14-18 not carried out according to the invention equally regularly clearly worse properties were produced (tests 16, 17 and 18) or no electrical steel strip could be produced at all under the conditions set in the respective tests (tests 14 and 15).

Therefore, with the invention a method for producing a grain-oriented electrical steel strip or sheet is provided, in which, generally speaking, the slab temperature of a thin slab, which consists of a steel having (in % wt.) Si: 2-6.5%, C: 0.02-0.15%, S: 0.01-0.1%, Cu: 0.1-0.5%, wherein the Cu to S content ratio is % Cu/% S>4, Mn: up to 0.1%, wherein the Mn to S content ratio is % Mn/% S<2.5, and optional contents of N, Al, Ni, Cr, Mo, Sn, V, Nb, is homogenised to 1000-1200° C., in which the thin slab is hot rolled into a hot strip having a thickness of 0.5-4.0 mm at an initial hot-rolling temperature of ≦1030° C. and a final hot-rolling temperature of ≧710° C. and with a thickness reduction both in the first and in the second hot-forming passes of ≧40% in each case, the hot strip is cooled and coiled into a coil, in which the hot scrip is cold rolled into a cold strip having a final thickness of 0.15-0.50 mm, in which an annealing separator is applied onto the annealed cold strip, and in which final annealing of the cold strip provided with the annealing separator is carried out to form a Goss texture.

TABLE 1

| Melt | Si | C | Cu | S | Mn | Al | N |
|---|---|---|---|---|---|---|---|
| A | 3.18 | 0.046 | 0.207 | 0.031 | 0.056 | 0.0030 | 0.0025 |
| B | 3.23 | 0.051 | 0.124 | 0.036 | 0.114 | 0.0020 | 0.0032 |

| Melt | Ni | Cr | Mo | Sn | V | Nb |
|---|---|---|---|---|---|---|
| A | 0.016 | 0.067 | 0.002 | 0.011 | 0.0010 | 0.0008 |
| B | 0.021 | 0.071 | 0.003 | 0.022 | 0.0008 | 0.0011 |

Data in % wt.
Remainder iron and unavoidable impurities
Melt A: according to the invention
Melt B: not according to the invention

TABLE 2

| Melt | % Mn/% S | % Cu/% S | SRT [° C.] |
|---|---|---|---|
| A | 1.81 | 6.7 | 1050 |
| B | 3.17 | 3.4 | 1035 |

TABLE 3

| | | | Proportion |
|---|---|---|---|
| | | | magnetic |
| Melt | P_{1.7} [w/kg] | J₈₀₀ [T] | degradation |
| A | 1.19 | 1.86 | 0.1% |
| B | 1.36 | 1.81 | 60% |

TABLE 4

| Melt | Si | C | Cu | S | Mn | Al | N |
|---|---|---|---|---|---|---|---|
| C | 3.31 | 0.056 | 0.212 | 0.038 | 0.061 | 0.029 | 0.0089 |
| D | 3.28 | 0.049 | 0.156 | 0.022 | 0.152 | 0.028 | 0.0078 |

| Melt | Ni | Cr | Mo | Sn | V | Nb |
|---|---|---|---|---|---|---|
| C | 0.025 | 0.062 | 0.003 | 0.015 | 0.0009 | 0.0015 |
| D | 0.015 | 0.061 | 0.004 | 0.011 | 0.0012 | 0.0006 |

Data in % wt.
Remainder iron and unavoidable impurities
Melt C: according to the invention
Melt D: not according to the invention

TABLE 5

| Melt | % Mn/% S | % Cu/% S | SRT [° C.] |
|---|---|---|---|
| C | 1.60 | 5.6 | 1062 |
| D | 6.91 | 7.1 | 1055 |

TABLE 6

| | P_{1.7} [W/kg] | | | | |
|---|---|---|---|---|---|
| Melt | <0.80 | 0.80-<0.85 | 0.85-<0.90 | 0.90-<0.95 | ≧0.95 |
| C | 70 | 25 | 5 | 0 | 0 |
| D | 0 | 0 | 30 | 40 | 30 |

TABLE 7

| | SRT | ΘF1 | ΘF2 | P_{1.7} [W/kg] | | | | |
|---|---|---|---|---|---|---|---|---|
| Test | [° C.] | [° C.] | [° C.] | <0.80 | 0.80-<0.85 | 0.85-<0.90 | 0.90-<0.95 | ≧0.95 |
| 1 | 1077 | 990 | 952 | 38 | 42 | 20 | 0 | 0 |
| 2 | 1070 | 974 | 934 | 81 | 15 | 4 | 0 | 0 |
| 3 | 1062 | 954 | 920 | 84 | 12 | 4 | 0 | 0 |
| 4 | 1060 | 981 | 939 | 82 | 12 | 6 | 0 | 0 |
| 5 | 1057 | 964 | 932 | 74 | 18 | 8 | 0 | 0 |
| 6 | 1055 | 974 | 941 | 78 | 16 | 6 | 0 | 0 |
| 7 | 1052 | 963 | 921 | 82 | 15 | 3 | 0 | 0 |
| 8 | 1050 | 980 | 941 | 81 | 10 | 9 | 0 | 0 |
| 9 | 1052 | 961 | 922 | 83 | 12 | 5 | 0 | 0 |
| 10 | 1050 | 968 | 923 | 79 | 25 | 6 | 0 | 0 |
| 11 | 1049 | 962 | 922 | 80 | 14 | 6 | 0 | 0 |
| 12 | 1048 | 950 | 919 | 65 | 22 | 13 | 0 | 0 |
| 13 | 1050 | 956 | 920 | 72 | 25 | 3 | 0 | 0 |
| 14 | 1105 | 1040 | *) | | | | | |
| 15 | 1090 | 1029 | *) | | | | | |
| 16 | 1081 | 1020 | 985 | 0 | 0 | 42 | 5 | 53 |
| 17 | 1048 | 925 | 888 | 0 | 0 | 43 | 45 | 12 |
| 18 | 1046 | 910 | 877 | 0 | 0 | 32 | 38 | 30 |

*) Rolling not possible, material ruptured in the first pass
Tests 1-13 according to the invention
Tests 14-18 not according to the invention

1. A method for producing a grain-oriented electrical steel strip or sheet intended for electrotechnical applications, comprising the following production steps:
a) providing a thin slab which consists of a steel which contains, in addition to iron and unavoidable impurities, (in % wt.)
Si: 2-6.5%,
C: 0.02-0.15%,
S: 0.01-0.1%,
Cu: 0.1-0.5%,
wherein % Cu/% S>4 applies for the % Cu/% S ratio of the Cu content % Cu to the S content % S,
Mn: up to 0.1%,
wherein in the presence of Mn, % Mn/% S<2.5 applies for the % Mn/% S ratio of the Mn content % Mn to the S content % S,
and in each case optionally
N: up to 0.003%,
contents of acid-soluble Al of up to 0.08%, wherein in the presence of Al, % N/% Al<0.25 applies for the % N/% Al ratio of the N content % N to the Al content % Al,
one or more elements from the group “Ni, Cr, Mo, Sn” with contents of up to 0.2% in each case,
one or more elements from the group “V, Nb” with contents of up to 0.1% in each case,
b) homogenising the temperature of the thin slab to a slab temperature of 1000-1200° C.,
c) hot rolling the thin slab into a hot strip having a thickness of 0.5-4.0 mm, wherein the hot-rolling initial temperature of the slab at the start of hot rolling is less than 1030° C. and the hot-rolling final temperature is at least 710° C. and both the first and the second hot-forming passes are carried out with a thickness reduction of at least 40%,
d) cooling the hot strip,
e) coiling the hot strip into a coil,
f) cold rolling the hot strip into a cold strip having a final thickness of 0.15-0.50 mm,
g) applying an annealing separator onto the surface of the annealed cold strip,
h) final annealing of the cold strip provided with the annealing separator to form a Goss texture.

2. The method according to claim 1, wherein the thickness of the thin slab is at most 100 mm.

3. The method according to claim 1, wherein the casting rate when casting the billet, from which the thin slabs are separated, is at most 4.6 m/min.

4. The method according to claim 1, wherein the overheating temperature of the melt in the tundish is 3-50 K.

5. The method according to claim 4, wherein the overheating temperature of the melt in the tundish is 25-50 K.

6. The method according to claim 1, wherein the Si content of the thin slab is 2.5-4.0% wt.

7. The method according to claim 1, wherein the C content of the thin slab is 0.040-0.085% wt.

8. The method according to claim 1, wherein the acid-soluble Al content of the thin slab is 0.020-0.040% wt.

9. The method according to claim 1, wherein the temperature in the first hot-forming pass is 950-1000° C.

10. The method according to claim 1, wherein the temperature in the second hot-forming pass is 920-980° C.

11. The method according to claim 1, wherein the hot strip is subjected to hot-strip annealing at 950-1150° C.

12. The method according to claim 1, wherein the cold rolling is carried out in two or more stages.

13. The method according to claim 1, wherein the cold strip is subjected to decarburizing annealing.

14. The method according to claim 1, wherein the cold strip is subjected to nitriding annealing under an NH₃-containing atmosphere.

15. The method according to claim 1, wherein the finally annealed electrical steel strip or sheet is subjected to a domain refining treatment.
